(19) United States
(12) Patent Application Publication
(10) Pub. No.: US 2012/0084823 A1
(43) Pub. Date: Apr. 5, 2012

(54) CONTENT PLAYING SYSTEM

(76) Inventor: Kozo Satoda, Tokyo (JP)

(21) Appl. No.: 13/376,934

(22) PCT Filed: Mar. 29, 2010
(86) PCT No.: PCT/JP2010/002235

§ 371 Date: Dec. 8, 2011

(30) Foreign Application Priority Data
Jun. 15, 2009 (JP) 2009-142281

(51) Int. Cl. H04N 21/20

(52) U.S. Cl. 725/93

(57) ABSTRACT

A content playing system 600 includes a plurality of terminal devices 610, etc. and a content delivery system 620. The content delivery system converts the format of an acquired content data from a first format into a second format. When receiving a transmission request from a terminal device, the content delivery system sends the content data having the first format or the second format to that terminal device. Further, the content delivery system acquires stop position information denoting a stop position where a terminal device has stopped playing the contents. The content delivery system sends the content data after a terminal device has stopped playing the contents in the case of receiving the transmission request from another terminal device to the other terminal device from the position denoted by the stop position information.

### TECHNICAL FIELD

The present invention relates to content playing systems including a content delivery system for delivering content data denoting contents, and terminal devices for playing the contents.

### BACKGROUND ART

As a content playing system, the content playing system disclosed in Patent Document 1 includes a content delivery system for delivering content data denoting contents, and a terminal device for playing the contents.

The content delivery system receives a content data sent by an external device and stores the received content data. Further, the content delivery system converts the format of the received content data into a format playable by the terminal device. Then, the content delivery system sends the converted content data to the terminal device.

The terminal device receives the content data, and plays the contents denoted by the received content data. By virtue of this, a user can play the contents by utilizing the terminal device capable of playing only a content data different in format from that received by the content delivery system. That is, the user can play the contents even when utilizing any of a plurality of terminal devices different in the format for playable content data.

[Patent Document 1] JP 2003-339041 A

However, in the above content playing system, the user playing contents on a first terminal device may desire to once stop the play and then restart playing the contents on a second terminal device. In this case, in the above content playing system, there is a problem that the user cannot continuously play contents between a plurality of terminal devices different in the format for playable content data.

### SUMMARY

In view of the above, an exemplary object of the present invention is to provide a content playing system capable of solving the above problem: “the user cannot continuously play contents between a plurality of terminal devices different in the format for playable content data”.

In order to achieve the exemplary object, an aspect in accordance with the present invention provides a content playing system including a plurality of terminal devices, and a content delivery system.

Further, each of the plurality of terminal devices includes: a transmission request sending means for sending a transmission request for requesting to send a content data denoting a content to the content delivery system, a content data receiving means for receiving the content data from the content delivery system, and a content playing means for playing the content denoted by the received content data.

In addition, the content delivery system includes: a content data acquisition means for acquiring the content data having a first format; a content data conversion means for converting the format of the acquired content data from the first format into a second format different from the first format; a transmission request receiving means for receiving the transmission request from the terminal device; a content data sending means for, when the transmission request was received, sending the content data having the first format or the content data having the second format to the terminal device which sent in the transmission request; and a stop position information acquisition means for, when the terminal device has stopped playing the content, acquiring stop position information denoting the stopped position.

Further, the content data sending means is configured to, in the case of receiving, after one of the plurality of terminal devices has stopped playing the content, the transmission request sent by another one of the plurality of terminal devices, send the content data to the other terminal device from the position denoted by the acquired stop position information.

Further, another aspect in accordance with the present invention provides a content delivery method for application to a content playing system including a plurality of terminal devices and a content delivery system. Further, the content delivery method includes: acquiring a content data denoting a content and having a first format by the content delivery system; converting the format of the acquired content data from the first format into a second format different from the first format by the content delivery system; sending a transmission request for requesting to send the content data denoting the content to the content delivery system by the terminal device; receiving the transmission request from the terminal device by the content delivery system; sending the content data having the first format or the content data having the second format by the content delivery system to the terminal device which sent in the transmission request when the transmission request was received; receiving the content data from the content delivery system by the terminal device; playing the content denoted by the received content data by the terminal device; acquiring, when the terminal device has stopped playing the content, stop position information denoting the stopped position by the content delivery system; and in the case of receiving, after one of the plurality of terminal devices has stopped playing the content, the transmission request sent by another one of the plurality of terminal devices, sending the content data to the other terminal device from the position denoted by the acquired stop position information, by the content delivery system.

Further, still another aspect in accordance with the present invention provides a content delivery system configured to be communicable with each of a plurality of terminal devices.

Further, the content delivery system includes: a content data acquisition means for acquiring a content data denoting a content and having a first format; a content data conversion means for converting the format of the acquired content data from the first format into a second format different from the first format; a transmission request receiving means for receiving a transmission request for requesting to send the content data from the terminal device; a content data sending means for, when the transmission request was received, sending the content data having the first format or the content data having the second format to the terminal device which sent in the transmission request; and a stop position information acquisition means for, when the terminal device has stopped playing the content, acquiring stop position information denoting the stopped position, wherein the content data sending means is configured to, in the case of receiving, after one of the plurality of terminal devices has stopped playing the content, the transmission request sent by another one of the plurality of terminal devices, send the content data to the other terminal device from the position denoted by the acquired stop position information.

Further, still another aspect in accordance with the present invention provides a computer program including instructions for causing a content delivery device configured to be communicable with each of a plurality of terminal devices to realize: a content data acquisition means for acquiring a content data denoting a content and having a first format; a content data conversion means for converting the format of the acquired content data from the first format into a second format different from the first format; a transmission request receiving means for receiving a transmission request for requesting to send the content data from the terminal device; a content data sending means for, when the transmission request was received, sending the content data having the first format or the content data having the second format to the terminal device which sent in the transmission request; and a stop position information acquisition means for, when the terminal device has stopped playing the content, acquiring stop position information denoting the stopped position; wherein the content data sending means is configured to, in the case of receiving, after one of the plurality of terminal devices has stopped playing the content, the transmission request sent by another one of the plurality of terminal devices, send the content data to the other terminal device from the position denoted by the acquired stop position information.

Because the present invention is such configured as described hereinabove, the user can continuously play contents between a plurality of terminal devices different in the format for playable content data.

### BRIEF DESCRIPTION OF DRAWINGS

FIG. 1 shows a schematic configuration of a content playing system in accordance with a first exemplary embodiment of the present invention;

FIG. 2 is a block diagram showing a functional outline of the content playing system in accordance with the first exemplary embodiment of the present invention;

FIG. 3 is a sequence diagram showing an operation of the content playing system in accordance with the first exemplary embodiment of the present invention when a user carries out a user authentication process for utilizing the service;

FIG. 4 is a sequence diagram showing an operation of the content playing system in accordance with the first exemplary embodiment of the present invention when the user carries out a recording reservation process for reserving the recording of a broadcast program;

FIG. 5 is a sequence diagram showing an operation of the content playing system in accordance with the first exemplary embodiment of the present invention when the user carries out a recording process for recording a broadcast program;

FIG. 6 is a sequence diagram showing an operation of the content playing system in accordance with the first exemplary embodiment of the present invention when the user carries out a playing process for playing the contents on a terminal device;

FIG. 7 is another sequence diagram showing an operation of the content playing system in accordance with the first exemplary embodiment of the present invention when the user carries out a playing process for playing the contents on a terminal device;

FIGS. 8A and 8B are tables showing examples of content reservation information and terminal information stored in a utilization information recording portion in accordance with the first exemplary embodiment of the present invention;

FIG. 9 is a block diagram showing a functional outline of a content recording delivery device in accordance with a second exemplary embodiment of the present invention;

FIG. 10 is a sequence diagram showing an operation of a content playing system in accordance with the second exemplary embodiment of the present invention when a user carries out a recording process for recording a broadcast program;

FIG. 11 is a block diagram showing a functional outline of a content playing system in accordance with a third exemplary embodiment of the present invention;

FIG. 12 is a sequence diagram showing an operation of the content playing system in accordance with the third exemplary embodiment of the present invention when a user carries out a recording process for recording a broadcast program;

FIG. 13 is a sequence diagram showing an operation of the content playing system in accordance with the third exemplary embodiment of the present invention when the user carries out a playing process for playing contents on a terminal device; and

FIG. 14 is a block diagram showing a functional outline of a content playing system in accordance with a fourth exemplary embodiment of the present invention.

### EXEMPLARY EMBODIMENTS

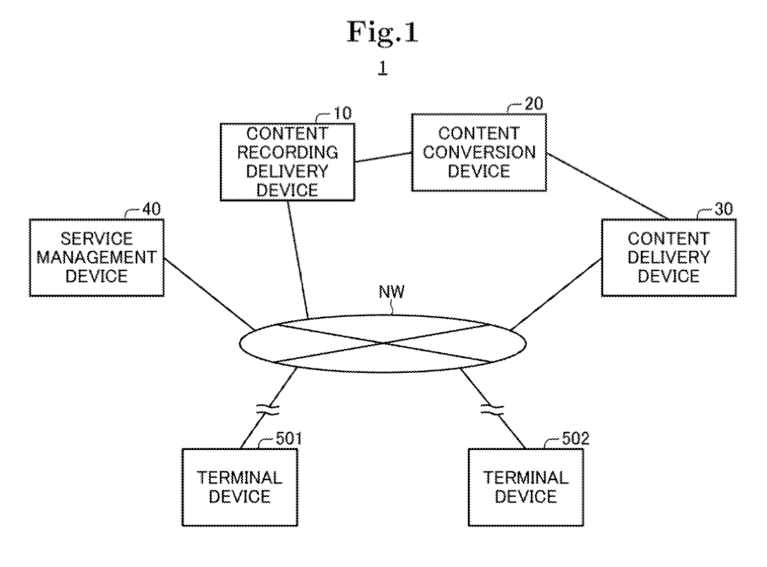

Hereinbelow, referring to FIGS. 1 to 14, descriptions will be made with respect to each exemplary embodiment of a content playing system, a content delivery method, a content delivery system, and a computer program in accordance with the present invention.

### A First Exemplary Embodiment

The content playing system in accordance with a first exemplary embodiment of the present invention manages content data denoting contents with a server device. There are various contents such as contents of recorded broadcast programs, VoD (Video On Demand) contents such as rental videos and the like on networks, home videos recorded by users on a personal basis, etc.

This content playing system reproduces or plays contents by the terminal devices receiving content data from the serve device. Therefore, a user of a terminal device can play a large number of contents without making the terminal device store a large amount of content data.

Further, the content playing system converts the format of the content data into a format playable by the terminal devices. Therefore, the user can play the contents even when utilizing any of a plurality of terminal devices different in the format for playable content data.

In addition, when a first terminal device has stopped playing the contents, and then if a transmission request is received from a second terminal device, the content playing system sends the content data to the second terminal device from the position at which the first terminal device has stopped playing. Therefore, the user can continuously play the contents between a plurality of terminal devices different in the format for playable content data. For example, the user can utilize a cellular telephone to play the rest of the contents which were played halfway with a TV receiver at home.

As shown in FIG. 1, a content playing system 1 in accordance with the first exemplary embodiment includes a content recording delivery device 10, a content conversion device 20, a content delivery device 30, a service management device 40, and a plurality of terminal devices 501 and 502 (two in the present example). Further, the content recording delivery device 10, content conversion device 20, content delivery device 30 and service management device 40 constitute a content delivery system.

The content recording delivery device 10, the content delivery device 30 and the service management device 40 are connected to be communicable with each other through a communications line NW. Further, the content conversion device 20 is connected to be communicable with the content recording delivery device 10 and the content delivery device 30, respectively.

Further, the terminal device 501 is connected to be communicable with the content recording delivery device 10 and the service management device 40, respectively, through an unshown communications line (for example, NGN: Next Generation Network, FTTH: Fiber To The Home, or the like). Further, the terminal device 502 is also connected to be communicable with the content recording delivery device 10 and the service management device 40, respectively, through another unshown communications line (for example, the third generation cellular telephone network or the like).

The content recording delivery device 10 receives (acquires) a content data and stores (records) the received content data. Then, the content recording delivery device 10 sends (delivers) the stored content data to the terminal device 501.

The content recording delivery device 10 is a server device. The content recording delivery device 10 is provided with an unshown CPU (Central Processing Unit) and storage device (memory, and HDD: Hard Disk Drive). The content recording delivery device 10 is configured to realize the aftermentioned function by causing the CPU to execute a computer program stored in the storage device.

Each of the content conversion device 20, the content delivery device 30 and the service management device 40 also has the same configuration as the content recording delivery device 10. The content conversion device 20 converts the format of the content data stored by the content recording delivery device 10 into another format (carries out a conversion of file format). The content delivery device 30 sends the content data converted by the content conversion device 20 to the terminal device 502. The service management device 40 manages the service provided by the content recording delivery device 10, content conversion device 20 and content delivery device 30.

The terminal device 501 is provided with a set-top box and a TV receiver connected with each other. The set-top box receives the content data denoting the contents (a motion picture composed of sound and picture in the present example) from the content recording delivery device 10, and outputs the contents to the TV receiver based on the received content data. That is, the terminal device 501 plays the contents based on the content data received from the content recording delivery device 10.

The terminal device 501 is configured to be capable of playing a content data having a first format, i.e., the MPEG-2 format in the present example (MPEG: Moving Picture Experts Group).

The terminal device 502 is a cellular telephone. The terminal device 502 receives a content data from the content delivery device 30 and plays the contents based on the received content data. The terminal device 502 is configured to be capable of playing a content data having a second format different from the first format (the H. 264 format in the present example).

Further, the first and second formats are not limited to the above combination. For example, the first and second formats may be an arbitrary combination of such as the MPEG-2 format, the H. 264 format, the WMV (Windows Media™ Video) format, and the Flash™ format.

Further, although the first and second formats utilize encoding methods different from each other in the present example, they may as well utilize an identical encoding method but utilize different resolutions, bit rates and/or audio sampling frequencies from each other.

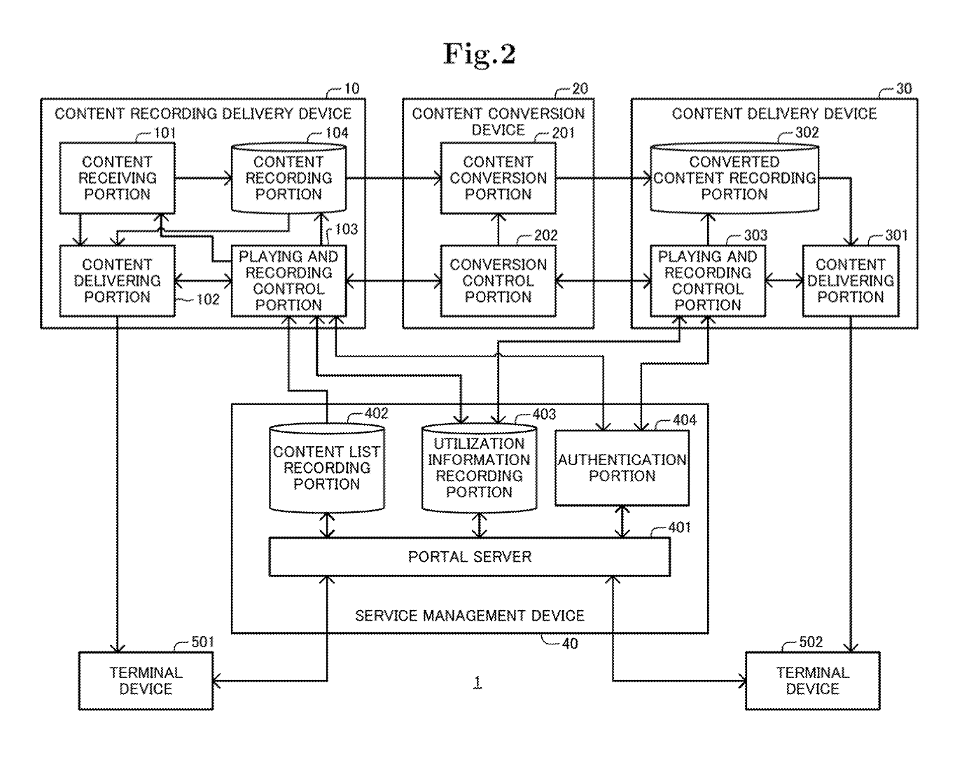

FIG. 2 is a block diagram showing a function of the content playing system 1 configured in the above manner. The function of the content recording delivery device 10 includes a content receiving portion 101 (a content data acquisition means), a content delivering portion 102 (part of a content data transmission means and part of a transmission request receiving means), a playing and recording control portion 103, and a content recording portion 104 (part of a content data storage means). The function of the content conversion device 20 includes a content conversion portion 201 (a content data conversion means), and a conversion control portion 202.

The function of the content delivery device 30 includes a content delivering portion 301 (part of a content data transmission means and part of a transmission request receiving means), a converted content recording portion 302 (part of a content data storage means), and a playing and recording control portion 303.

The function of the service management device 40 includes a portal server 401 (a format specification information acquisition means, a recording instruction receiving means and a stop position information acquisition means), a content list recording portion 402, a utilization information recording portion 403 (a format specification information storage means and a stop position information storage means), and an authentication portion 404.

The content receiving portion 101 receives a content data delivered through broadcasting from outside the content playing system 1 (an external device) to the content recording delivery device 10. In the present example, this content data has the first format.

The content receiving portion 101 accepts a recording start instruction from the playing and recording control portion 103. The recording start instruction includes content specification information for specifying contents, and instructs to start recording the contents. On accepting the recording start instruction, the content receiving portion 101 starts to acquire the content data denoting the above contents among the received content data.

Further, the content receiving portion 101 accepts a recording end instruction from the playing and recording control portion 103. The recording end instruction includes content specification information for specifying contents, and instructs to end recording the contents. On accepting the recording end instruction, the content receiving portion 101 ends acquiring the content data denoting the above contents.

Further, the content receiving portion 101 may as well be configured to receive content data only during the period after accepting the recording start instruction and before accepting the recording end instruction.

The playing and recording control portion 103 acquires content reservation information (a recording instruction) stored in the utilization information recording portion 403 each time a preset acquisition period has passed. The content reservation information is content specification information for specifying contents (information denoting the start time and date of starting the contents, the end time and date of ending the contents, and the broadcast channel in the present example). The content reservation information is stored in the utilization information recording portion 403 in association with user identification information for identifying users.

At the start time of the date denoted by the acquired content reservation information, the playing and recording control portion 103 sends out the recording start instruction to the content receiving portion 101. Further, at the end time of the date denoted by the acquired content reservation information, the playing and recording control portion 103 sends out the recording end instruction to the content receiving portion 101.

Having sent out the recording start instruction to the content receiving portion 101, the playing and recording control portion 103 acquires the user identification information stored in association with the content reservation information which is the base for sending out the recording start instruction. Then, the playing and recording control portion 103 acquires terminal information stored in the utilization information recording portion 403 in association with the acquired user identification information.

The terminal information includes format specification information for specifying the format with which the terminal devices 501 and 502 can play the contents. For example, the format specification information denotes resolution, bit rate, audio sampling frequency, and encoding method (codec, profile and level of codec, and the like).

The playing and recording control portion 103 sends a conversion request to the conversion control portion 202. The conversion request includes the format specification information included in the acquired terminal information, and content data identification information for identifying the content data denoting the contents specified by the above content reservation information.

The content recording portion 104 stores or causes the storage device to store the content data acquired by the content receiving portion 101. That is, the content recording portion 104 stores the content data having the first format. Further, the content recording portion 104 stores the acquired data, in turn, each time the content receiving portion 101 acquires the data of a preset size among the content data. Further, the content recording portion 104 may as well be configured to store the data, in turn, during the last processing period, each time a preset processing period has passed.

The content delivering portion 102 receives a transmission request sent by the terminal device 501. The transmission request includes content specification information for specifying the contents, and playing start position information denoting the position of starting to play the contents, and requests to send the content data denoting the contents.

On receiving the transmission request, the content delivering portion 102 sends the content data to the terminal device 501 if the content recording portion 104 stores the content data denoting the contents specified by the transmission request. At the time, the content delivering portion 102 sends the content data from the position denoted by the playing start position information included in the transmission request.

Further, if the content receiving portion 101 is just acquiring the content data denoting the contents specified by the above transmission request, then the content delivering portion 102 sends the content data acquired by the content receiving portion 101 to the terminal device 501. At the time, the content delivering portion 102 sends the content data from the position denoted by the playing start position information included in the transmission request.

The conversion control portion 202 receives a conversion request from the playing and recording control portion 103. The conversion control portion 202 sends out a conversion instruction to the content conversion portion 201. The conversion instruction includes the format specification information and content data identification information included in the received conversion request. The conversion instruction is information including the content data identification information and format specification information, and instructs to convert the format of the content data into a format specified by the format specification information.

The content conversion portion 201 accepts the conversion instruction from the conversion control portion 202. On accepting the conversion instruction, the content conversion portion 201 acquires the content data identified by the conversion instruction among the content data stored in the content recording portion 104. Then, the content conversion portion 201 converts the format of the acquired content data from the first format into a format specified by the conversion instruction (the second format, for example).

Further, each time the content recording portion 104 stores data of the preset size among the content data, the content conversion portion 201 converts the stored data in turn. That is, at the time of acquiring part of the content data, the content conversion portion 201 converts the format of the acquired part of the content data.

By virtue of this, the content delivery system can send the converted content data to the terminal device 502 before acquiring all the content data. Therefore, for example, even if the content data is delivered through broadcasting from an external device to the content delivery system, the terminal device 502 can still play the contents during the delivery of the content data.

The content conversion portion 201 sends the converted data to the converted content recording portion 302. Further, the content conversion portion 201 may as well be configured to convert the data newly stored in the content recording portion 104 during the last processing period, in turn, each time a preset processing period has passed.

Further, the content conversion portion 201 may as well be configured to receive the content data from the content receiving portion 101 without passing through the content recording portion 104.

The converted content recording portion 302 receives the content data sent by the content conversion portion 201. The converted content recording portion 302 stores the received content data.

Further, it is preferable that the content conversion portion 201 be configured to communicate data between the content recording portion 104 and the converted content recording portion 302 by utilizing file sharing protocol, file transfer protocol, streaming protocol, or the like.

The content delivering portion 301 receives a transmission request sent by the terminal device 502. On receiving the transmission request, the content delivering portion 301 sends a content data to the terminal device 502 if the converted content recording portion 302 stores the content data denoting the contents specified by that transmission request. At the time, the content delivering portion 301 sends the content data from the position denoted by the playing start position information included in the transmission request. The playing and recording control portion 303 has the same function as the content delivering portion 301.

Each of the terminal devices 501 and 502 sends terminal information to the portal server 401. The portal server 401 receives the terminal information sent by the terminal devices 501 and 502, respectively. The utilization information recording portion 403 stores the terminal information received by the portal server 401 in association with the user identification information for identifying the user of the terminal devices 501 and 502.

The content list recording portion 402 stores a content list which is the information denoting the content chart. The content chart denoted by the content list includes the contents as the program on the air, and the contents of usable VoD. The content list further includes content specification information for specifying the contents.

In the present example, the service management device 40 is configured to acquire the content list from an external device other than the service management device 40 (for example, a content provider), and store the acquired content list into the content list recording portion 402. Further, the service management device 40 may as well be configured to acquire the content list from multiplex information in the broadcast.

Further, any of the terminal devices 501 and 502 sends a content list request to the portal server 401 according to a content list request instruction inputted by the user. The content list request is information denoting a request to send the content list stored in the content list recording portion 402.

The portal server 401 receives the content list request sent by any of the terminal devices 501 and 502. On receiving the content list request, the portal server 401 sends the content list stored in the content list recording portion 402 to any of the terminal devices 501 and 502 which sent in the content list request.

Further, any of the terminal devices 501 and 502 receives the content list from the portal server 401. Any of the terminal devices 501 and 502 sends content reservation information (a recording instruction) based on the received content list to the portal server 401 according to a reservation information transmission instruction inputted by the user (a recording instruction transmission means).

The portal server 401 receives the content reservation information sent by any of the terminal devices 501 and 502. The utilization information recording portion 403 stores the content reservation information received by the portal server 401 in association with the user identification information for identifying the user of any of the terminal devices 501 and 502.

Further, any of the terminal devices 501 and 502 sends a recording content list request to the portal server 401 according to a recording content list request instruction inputted by the user. The recording content list request is information denoting a request to send the recording content list.

The recording content list is information denoting the contents specified by the content reservation information, the contents denoted by the content data stored in the content recording portion 104 and the converted content recording portion 302, and the content chart denoted by the content data being stored into the content recording portion 104 and the converted content recording portion 302. The recording content list includes content specification information for specifying the contents, and the (aftermentioned) stop position information denoting the position at which the playing of the contents was stopped in the past.

The portal server 401 receives the recording content list request sent by any of the terminal devices 501 and 502. On receiving the recording content list request, the portal server 401 generates the recording content list denoting a content chart transmittable to any of the terminal devices 501 and 502 which sent in the recording content list request.

At the time, the portal server 401 generates the recording content list based on the content reservation information and the stop position information stored in the utilization information recording portion 403 in association with the user identification information for identifying the user of any of the terminal devices 501 and 502 which sent in the recording content list request. Then, the portal server 401 sends the generated recording content list to any of the terminal devices 501 and 502 which sent in the recording content list request.

Here, the stop position information is, as will be described hereinafter, information denoting the stop position if any of the terminal devices 501 and 502 stopped playing the contents in the past. Further, the portal server 401 utilizes the information denoting the starting position of the contents as the stop position information if the stop position information is not stored in the utilization information recording portion 403.

The terminal device 501 sends a transmission request based on the received recording content list to the content delivering portion 102 according to a transmission request instruction inputted by the user (a transmission request sending means). The transmission request includes the content specification information and the playing start position information. The playing start position information is set to the stop position information included in the recording content list or position information denoting the starting position of the contents according to the instruction inputted by the user.

The terminal device 501 receives the content data sent by the content delivering portion 102 according to the transmission request (a content data receiving means). The terminal device 501 plays the contents denoted by the received content data (a content playing means).

Further, the terminal device 501 sends a transmission stop request to the content delivering portion 102 according to a playing stop instruction inputted by the user. The transmission stop request is information requesting to stop sending the content data. On receiving the transmission stop request from the terminal device 501, the content delivering portion 102 stops sending the content data to the terminal device 501 which sent in the transmission stop request.

Further, having sent the transmission stop request, the terminal device 501 sends the stop position information denoting the position of stopping playing the contents and the content specification information for specifying the contents to the portal server 401.

In the same manner as the terminal device 501, the terminal device 502 sends a transmission request based on the received recording content list to the content delivering portion 301 according to a transmission request instruction inputted by the user (a transmission request sending means). The transmission request includes the content specification information and the playing start position information. The terminal device 502 receives the content data sent by the content delivering portion 301 according to the transmission request (a content data receiving means). The terminal device 502 plays the contents denoted by the received content data (a content playing means).

The terminal device 502 sends a transmission stop request to the content delivering portion 301 according to a playing stop instruction inputted by the user. The transmission stop request is information requesting to stop sending the content data. On receiving the transmission stop request from the terminal device 502, the content delivering portion 301 stops sending the content data to the terminal device 502 which sent in the transmission stop request.

Further, having sent the transmission stop request, the terminal device 502 sends the stop position information denoting the position of stopping playing the contents and the content specification information for specifying the contents to the portal server 401.

The portal server 401 receives the stop position information sent by any of the terminal devices 501 and 502. The portal server 401 stores the received stop position information and the content specification information into the utilization information recording portion 403 in association with the user identification information for identifying the user of any of the terminal devices 501 and 502 which sent in the information, that is, the terminal of the object of the stop position information (a stop position information storage processing means). That is, the utilization information recording portion 403 stores the stop position information and the content specification information received by the portal server 401 in association with the user identification information for identifying the user of any of the terminal devices 501 and 502 which sent in the information.

By virtue of such configuration, after any one of the multiple terminal devices 501 and 502 stops playing the contents, when receiving a transmission request sent by the other one of the multiple terminal devices 501 and 502, the content delivery system sends the content data from the stop position to that one of the terminal devices 501 and 502 which sent in the transmission request.

The authentication portion 404 carries out a user authentication process to authenticate the user of the terminal devices 501 and 502 according to the request from any of the terminal devices 501 and 502. By virtue of this, the authentication portion 404 acquires the user identification information for identifying the user of the terminal devices 501 and 502.

The authentication portion 404 sends authentication result information denoting the result of the user authentication process to the terminal devices 501 and 502. If the user authentication process by the authentication portion 404 is not successful, then even receiving the request from any of the terminal devices 501 and 502 with respect to the user authentication process, the portal server 401 will not carry out any process according to that request thereafter.

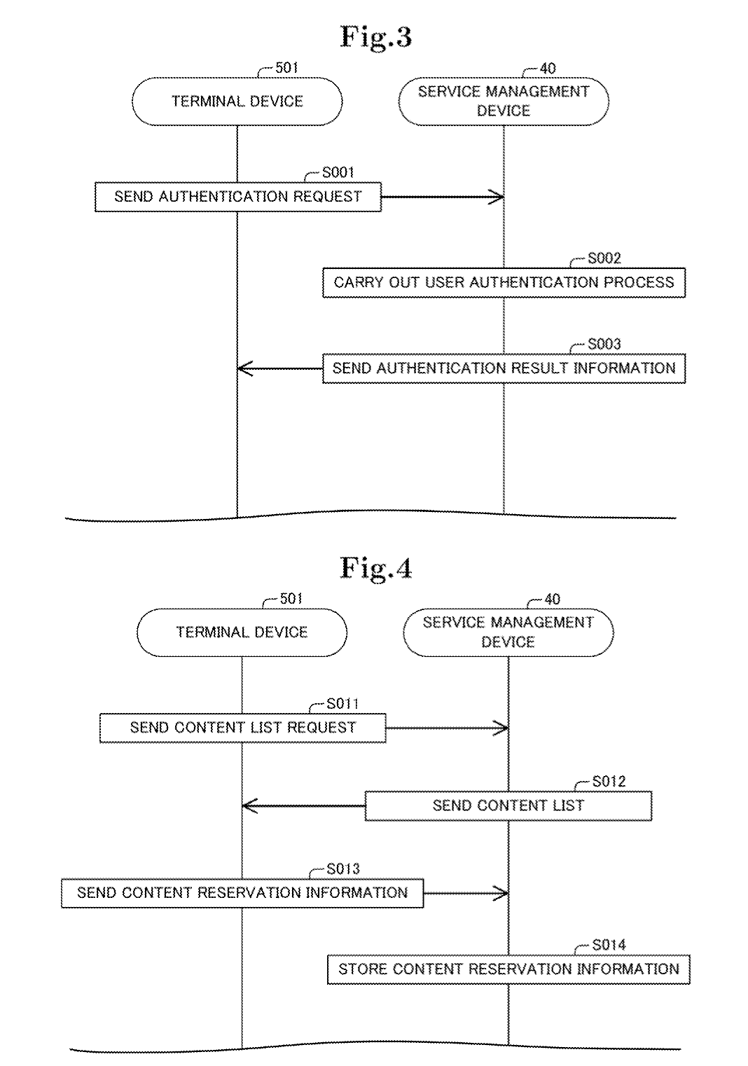

Next, descriptions with be made in particular with respect to operations of the above content playing system 1. First, referring to FIG. 3, explanations will be made with respect to the operation of the content playing system 1 relative to a user authentication process for a user to utilize the service.

The terminal device 501 sends an authentication request to the service management device 40 according to an authentication request instruction inputted by the user (step S001). The authentication request includes user identification information for identifying the user (a user ID, for example), and input information for authentication (a password, for example).

On receiving the authentication request, the service management device 40 carries out the user authentication process based on the received authentication request (step S002). In the present example, the service management device 40 carries out the user authentication process by determining whether or not the prestored user identification information and input information for authentication are consistent with the user identification information and input information for authentication included in the received authentication request.

If the user authentication process is successful (the prestored user identification information and input information for authentication are consistent with the user identification information and input information for authentication included in the received authentication request), then thereafter when receiving the request from the terminal device 501, the service management device 40 carries out a process according to the request. By virtue of this, the user of the terminal device 501 can utilize the service provided by the content playing system 1.

On the other hand, if the user authentication process is unsuccessful (the prestored user identification information and input information for authentication are inconsistent with the user identification information and input information for authentication included in the received authentication request), then thereafter even receiving the request from the terminal device 501, the service management device 40 will not carry out any process according to the request. By virtue of this, the user of the terminal device 501 cannot utilize the service provided by the content playing system 1.

Then, the service management device 40 sends authentication result information denoting the result of the user authentication process to the terminal device 501 (step S003).

Further, when the user authentication process is carried out for the terminal device 502, the content playing system 1 operates in the same manner as in the above case.

Further, the content playing system 1 may as well be configured to carry out the user authentication process by utilizing intrinsic identification information (device ID) of the terminal devices 501 and 502. Further, if IMS (IP Multimedia Subsystem) is applied to the content playing system 1, then the content playing system 1 may as well utilize the authentication process utilized in IMS as the above user authentication process.

Further, the content playing system 1 may as well be configured to carry out the user authentication process by utilizing biological information with fingerprint, vein, and the like.

Next, referring to FIG. 4, explanations will be made with respect to the operation of the content playing system 1 relative to a recording reservation process for the user to make reservation of recording broadcast programs.

The terminal device 501 sends a content list request to the service management device 40 according to a content list request instruction inputted by the user (step S011). On receiving the content list request from the terminal device 501, the service management device 40 sends the content list stored in the content list recording portion 402 to the terminal device 501 (step S012).

By virtue of this, the terminal device 501 receives the content list from the service management device 40. Then, the terminal device 501 outputs the received content list. The user of the terminal device 501 selects contents by referring to the content list. The terminal device 501 accepts the content specification information for specifying the contents selected by the user.

Then, the terminal device 501 sends the content reservation information (the recording instruction) including the accepted content specification information to the service management device 40 (step S013). On receiving the content reservation information from the terminal device 501, the service management device 40 stores the received content reservation information into the utilization information recording portion 403 in association with the user identification information for identifying the user of the terminal device 501.

Further, when the recording reservation process is carried out for the terminal device 502, the content playing system 1 operates in the same manner as in the above case.

In the present example, the content playing system 1 is configured to carry out the recording reservation process by utilizing the content list (program listing). However, the content playing system 1 may as well be configured to carry out the recording reservation process without utilizing the content list. In this case, it is preferable for the content playing system 1 to utilize, for example, information denoting the time, date and channel of the broadcast, or information for specifying the contents such as the G code and the like. In this case, the content playing system 1 can omit the processes of steps S011 and S012.

Further, the terminal devices 501 and 502 may as well be configured to acquire the content list from an external device other than the service management device 40 (for example, a content provider). Further, the terminal devices 501 and 502 may as well be configured to acquire the content list from multiplex information in the broadcast.

As the contents recorded by the user, when requesting upload of VoD contents or personal home videos, instant content recording may be carried out instead of reservation for content recording.

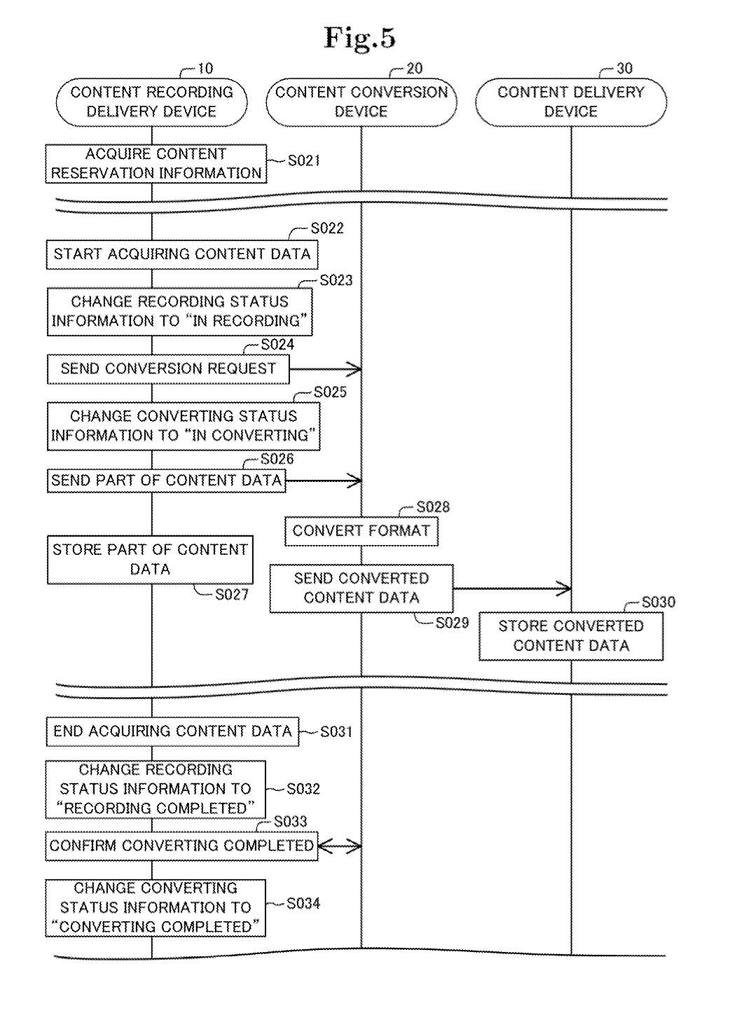

Next, referring to FIG. 5, explanations will be made with respect to the operation of the content playing system 1 relative to a recording process for recording broadcast programs.

The content recording delivery device 10 acquires the content reservation information stored in the utilization information recording portion 403 each time the acquisition period has passed (receives from the service management device 40, step S021).

At the start time of the date denoted by the acquired content reservation information, the content recording delivery device 10 starts to acquire the content data (step S022). Next, the content recording delivery device 10 changes recording status information included in the content reservation information stored in the utilization information recording portion 403 to “in recording” by sending the recording status information denoting “in recording” to the service management device 40 (step S023).

Further, the content recording delivery device 10 sends a conversion request including the format specification information (information denoting the second format in the present example) and the content data identification information to the content conversion device 20 (step S024).

At the time, the content recording delivery device 10 acquires the user identification information stored in association with the content reservation information which is the base of starting to acquire the content data in step S022. Further, the content recording delivery device 10 acquires the terminal information stored in the utilization information recording portion 403 in association with the acquired user identification information. Then, the content recording delivery device 10 utilizes the format specification information included in the acquired terminal information as the format specification information included in the conversion request.

Further, the content playing system 1 may as well be configured to restrict the playable terminal devices and/or the content data formats with respect to each set of contents.

Next, the content recording delivery device 10 changes converting status information included in the content reservation information stored in the utilization information recording portion 403 to “in converting” by sending the converting status information denoting “in converting” to the service management device 40 (step S025).

Then, the content recording delivery device 10 sends the acquired data among the content data started to acquire (that is, part of the content data) to the content conversion device 20 each time the data of a preset size is acquired (step S026).

Further, the content recording delivery device 10 stores the acquired data among the content data started to acquire (that is, part of the content data) each time the data of a preset size is acquired (step S027).

On the other hand, on receiving part of the content data from the content recording delivery device 10, the content conversion device 20 converts the format of the received part of the content data from the first format into a format specified by the received conversion request, i.e., the second format in the present example (step S028).

Then, the content conversion device 20 sends the converted part of the content data (conversion-completed content data) to the content delivery device 30 (step S029). By virtue of this, the content delivery device 30 receives the converted content data and stores the received converted content data (step S030).

The content playing system 1 repeats the process of the above steps S026 to S030 until the acquisition of the above content data is completed.

At the end time of the date denoted by the content reservation information, the content recording delivery device 10 ends acquiring the content data (step S031). Next, the content recording delivery device 10 changes the recording status information included in the content reservation information stored in the utilization information recording portion 403 to “recording completed” by sending the recording status information denoting “recording completed” to the service management device 40 (step S032).

Then, the content recording delivery device 10 confirms the completion of the conversion process by acquiring information denoting whether or not the content conversion device 20 has ended the process of converting the content data (step S033).

After confirming the completion of the conversion process, the content recording delivery device 10 changes the converting status information included in the content reservation information stored in the utilization information recording portion 403 to “converting completed” by sending the converting status information denoting “converting completed” to the service management device 40 (step S034).

Further, in the present example, while the content conversion device 20 converts the format of the content data into only one type of format (the second format in the present example), the same explanation is true with the case of converting it into a number of formats. In this case, the content recording delivery device 10 sends the conversion request to the content conversion device 20 a number of times.

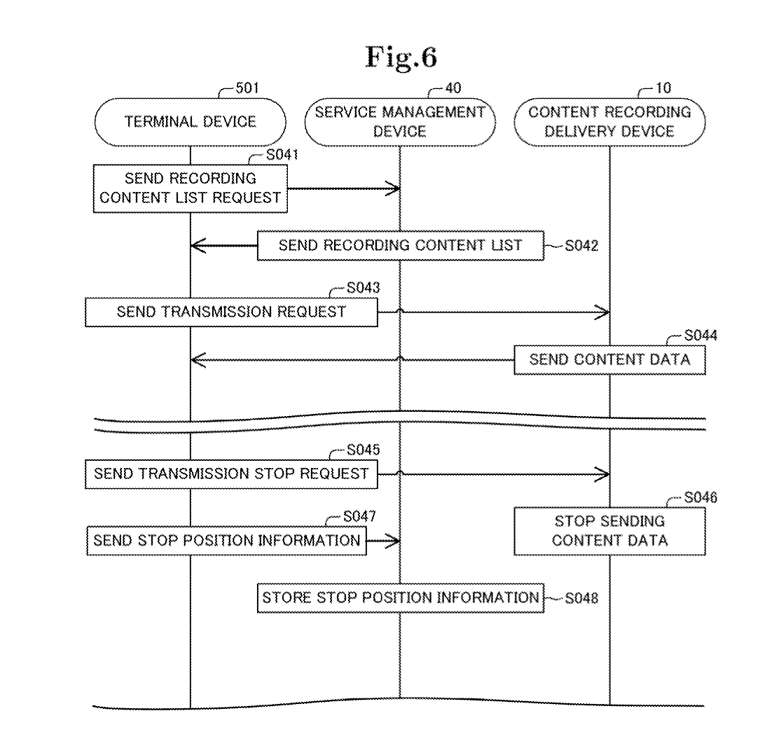

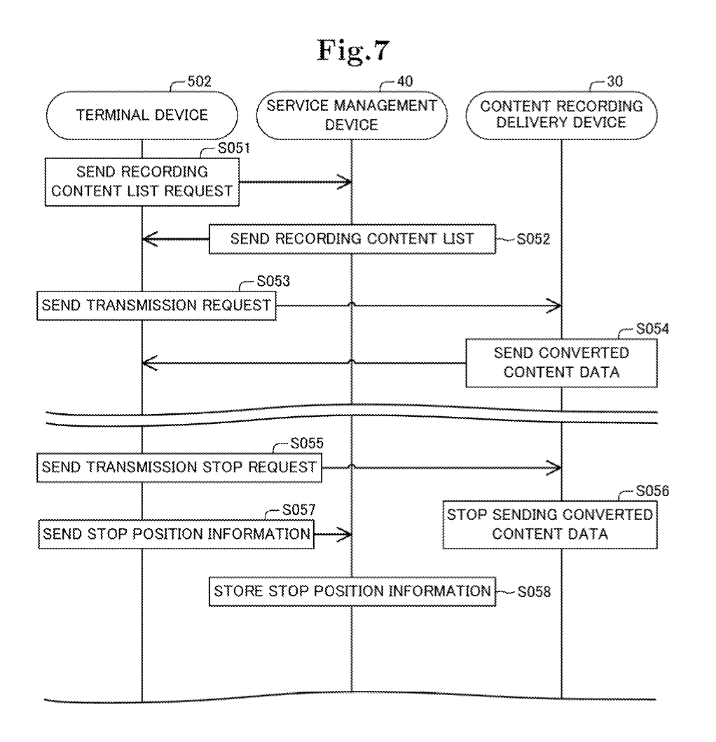

Next, referring to FIG. 6, explanations will be made with respect to the operation of the content playing system 1 relative to a playing process for the user to play contents on the terminal device 501. Now, the explanation will be continued assuming that the service management device 40 is successful in the user authentication process based on the authentication request sent by the user utilizing the terminal device 501.

The terminal device 501 sends a recording content list request to the service management device 40 according to a recording content list request instruction inputted by the user (step S041). On receiving the recording content list request from the terminal device 501, the service management device 40 generates a recording content list denoting a content chart transmittable to the terminal device 501 (playable by the user of the terminal device 501).

This recording content list includes the content reservation information and the stop position information stored in the utilization information recording portion 403 in association with the user identification information for identifying the user of the terminal device 501. Then, the service management device 40 sends the generated recording content list to the terminal device 501 (step S042).

On receiving the recording content list from the service management device 40, the terminal device 501 displays the content chart denoted by the received recording content list. The user of the terminal device 501 selects the contents desired to play and inputs a transmission request instruction denoting the selected contents while referring to the content chart on display. In the present example, the recording content list includes a URL (Universal Resource Location) including the information for specifying the content recording delivery device 10, the content specification information, and the stop position information.

The terminal device 501 sends a transmission request including the content specification information and playing start position information to the content recording delivery device 10 according to the inputted transmission request instruction (step S043). Here, the playing start position information is set to the stop position information included in the recording content list according to the instruction inputted by the user. Further, the playing start position information may as well be set to position information denoting the starting position of the contents according to the instruction inputted by the user.

On receiving the transmission request from the terminal device 501, the content recording delivery device 10 sends a content data denoting the contents specified by the transmission request (a content data having the first format) to the terminal device 501 from the position denoted by the playing start position information included in the transmission request (step S044).

On receiving the content data from the content recording delivery device 10, the terminal device 501 plays the contents denoted by the received content data. By virtue of this, the user of the terminal device 501 can play the contents.

The contents included in the recording content list include the contents which are now being received (recorded) and the contents which have already been received, by the content recording delivery device 10. The user can play the programs on the air only within the part of the contents already received by the content recording delivery device 10. On the other hand, the recording-completed contents can be played from any time (position) in the contents and, furthermore, can be trick-played such as fast fed, fast rewound, and the like.

Further, if the contents are programs in recording, then it is possible to trick-play within the part of the completed recording, but it is not possible to trick-play beyond the time of recording (the time of real-time broadcasting).

Even when sending the content data from the content receiving portion 101, it is still preferable for the content recording delivery device 10 to send the content data from the content recording portion 104 in the case of carrying out a trick play.

Further, for returning to or catching up the real-time broadcasting in the middle of a trick play, the content recording delivery device 10 may as well be configured to send the content data from any of the content recording portion 104 and the content receiving portion 101.

Further, the content recording delivery device 10 may as well be configured such that the playing and recording control portion 103 may control the content delivering portion 102 according to the performance of the terminal device 501 and the condition of the communications line. By virtue of this, the content recording delivery device 10 can reliably send the content data to the terminal device 501 (for example, at a stable transfer speed).

Then, the terminal device 501 sends a transmission stop request to the content recording delivery device 10 according to a playing stop instruction inputted by the user (step S045). On receiving the transmission stop request from the terminal device 501, the content recording delivery device 10 stops sending the content data to the terminal device 501 (step S046).

Further, having sent the transmission stop request, the terminal device 501 sends the stop position information denoting the position of stopping playing the contents and the content specification information for specifying the contents to the service management device 40 (step S047). On receiving the stop position information and the content specification information from the terminal device 501, the service management device 40 stores the stop position information and the content specification information in association with the user identification information for identifying the user of the terminal device 501 (step S048).

Further, in the present example, the content recording delivery device 10 is configured to acquire the stop position information by receiving the stop position information from the terminal device 501. However, it may as well be configured to acquire the stop position information based on the position at which the content recording delivery device 10 has stopped sending the content data.

Next, referring to FIG. 7, explanations will be made with respect to the operation of the content playing system 1 relative to a playing process for the user to play contents on the terminal device 502. Now, the explanation will be continued assuming that the service management device 40 is successful in the user authentication process based on the authentication request sent by the user utilizing the terminal device 502.

The terminal device 502 sends a recording content list request to the service management device 40 according to a recording content list request instruction inputted by the user (step S051). On receiving the recording content list request from the terminal device 502, the service management device 40 generates a recording content list denoting a content chart transmittable to the terminal device 502 (playable by the user of the terminal device 502).

This recording content list includes the content reservation information and the stop position information stored in the utilization information recording portion 403 in association with the user identification information for identifying the user of the terminal device 502. Then, the service management device 40 sends the generated recording content list to the terminal device 502 (step S052).

On receiving the recording content list from the service management device 40, the terminal device 502 displays the content chart denoted by the received recording content list. The user of the terminal device 502 selects the contents desired to play and inputs a transmission request instruction denoting the selected contents while referring to the content chart on display. In the present example, the recording content list includes a URL including the information for specifying the content delivery device 30, the content specification information, and the stop position information.

The terminal device 502 sends a transmission request including the content specification information and playing start position information to the content delivery device 30 according to the inputted transmission request instruction (step S053). Here, the playing start position information is set to the stop position information included in the recording content list according to the instruction inputted by the user. Further, the playing start position information may as well be set to position information denoting the starting position of the contents according to the instruction inputted by the user.

On receiving the transmission request from the terminal device 502, the content delivery device 30 sends a content data denoting the contents specified by the transmission request (a converted content data having the second format) to the terminal device 502 from the position denoted by the playing start position information included in the transmission request (step S054).

On receiving the content data from the content delivery device 30, the terminal device 502 plays the contents denoted by the received content data. By virtue of this, the user of the terminal device 502 can play the contents from the position at which the terminal device 501 stopped playing (that is, the rest of the contents played by the terminal device 501 in the past).

The contents included in the recording content list include the contents which are now being converted and the contents which have already been received, by the content conversion device 20. The user can play the contents being converted only within the part of the contents already received by the content delivery device 30. On the other hand, the converting-completed contents can be played from any time (position) in the contents and, furthermore, can be trick-played such as fast fed, fast rewound, and the like.

Further, if the contents are programs in converting, then it is possible to trick-play within the part of the completed converting, but it is not possible to trick-play beyond the time of converting.

Then, the terminal device 502 sends a transmission stop request to the content delivery device 30 according to a playing stop instruction inputted by the user (step S055). On receiving the transmission stop request from the terminal device 502, the content delivery device 30 stops sending the content data to the terminal device 502 (step S056).

Further, having sent the transmission stop request, the terminal device 502 sends the stop position information denoting the position of stopping playing the contents and the content specification information for specifying the contents to the service management device 40 (step S057). On receiving the stop position information and the content specification information from the terminal device 502, the service management device 40 stores the stop position information and the content specification information in association with the user identification information for identifying the user of the terminal device 502 (step S058).

Further, in the present example, the content delivery device 30 is configured to acquire the stop position information by receiving the stop position information from the terminal device 502. However, it may as well be configured to acquire the stop position information based on the position at which the content delivery device 30 has stopped sending the content data.

The content playing system 1 is configured to store the content data to be received at a time later than the current time according to the instruction inputted by the user. However, it may as well be configured to store the content data being started to receive at the current time.

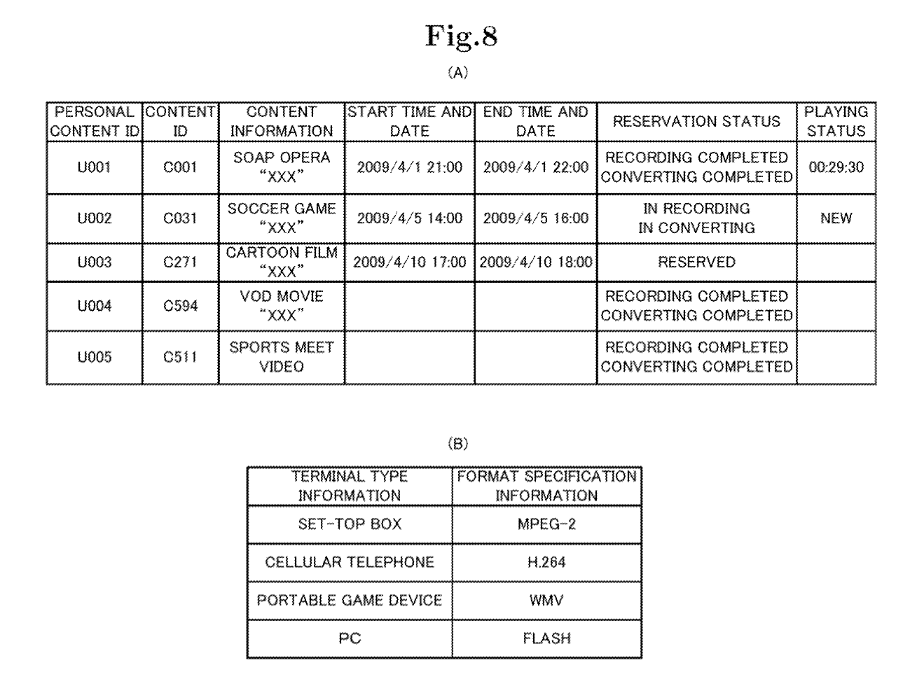

FIG. 8A is a table showing an example of the content reservation information stored in the utilization information recording portion 403. The content reservation information includes content data identification information for each user (personal content ID), content data identification information (content ID), information denoting a content outline (content information), information denoting the start time and date (the start time and date), information denoting the end time and date (the end time and date), recording status information and converting status information (reservation status), and stop position information (playing status).

The recording status information denotes the status of recording the content data, and is set to be any of the “on reservation” to indicate being reserved, “in recording” to indicate being recorded, and “recording completed” to indicate the completion of recording. The converting status information is set to be any of the “in conversion” to indicate being converted, and “conversion completed” to indicate the completion of converting.

Further, it is preferable that the content reservation information include the converting status information for each format if the content conversion device 20 converts the format of the content data into a plurality of formats.

If the contents have not been played so far, then the stop position information is set to be “NEW”, which denotes the starting position of the contents as the stop position information. If the contents have been played so far, then the stop position information is set to be information denoting the position (time) of stopping the play.

FIG. 8B is a table showing an example of the terminal information stored in the utilization information recording portion 403. The terminal information includes terminal type information denoting the type of a terminal device, and the format specification information for specifying the format with which the terminal devices 501 and 502 can play the contents.

The terminal type information is set to be “set-top box”, “cellular telephone”, “portable game device”, “PC”, or the like. The format specification information is set to be “MPEG-2”, “H. 264”, “WMV”, “Flash”, or the like. Further, the format specification information may as well include information denoting video codec, audio codec, or other restrictions.

Further, the terminal information may as well include information denoting protocols utilized to communicate content data (RTP: Real-time Transport Protocol/RTSP: Real-Time Streaming Protocol, HTTP: Hyper Text Transfer Protocol, and the like).

As explained hereinabove, according to the first exemplary embodiment of the content playing system in accordance with the present invention, when receiving a transmission request from any of the terminal devices 501 and 502, the content delivery system can send a content data having a format playable by the terminal devices 501 and 502 to any of the terminal devices 501 and 502. By virtue of this, the user can play the contents even when utilizing any of the plurality of terminal devices 501 and 502 different in the format for playable content data.

Further, according to the content playing system 1, when the user, who was playing the contents on the first terminal device 501, once stops the play, he/she can restart to play the contents on the second terminal device 502 later. That is, the user can continuously play the contents between the plurality of terminal devices 501 and 502 different in the format for playable content data. As a result, it is possible to enhance the convenience for the user.

In addition, in the first exemplary embodiment, the content delivery system sends the content data based on the stop position information stored in association with the user identification information. By virtue of this, even if a plurality of users utilize the content playing system 1, it is still possible for each user to continue playing the contents reliably. As a result, it is possible to enhance the convenience for the users.

In addition, in the first exemplary embodiment, the content delivery system acquires the format specification information for specifying the format with which the terminal devices 501 and 502 can play the contents, and converts the content data based on the acquired format specification information. By virtue of this, the content delivery system can convert the format of the acquired content data into a format with which the terminal devices 501 and 502 can play the contents. As a result, the content delivery system can avoid vainly converting the format of the acquired content data into some format with which the terminal devices 501 and 502 cannot play the contents.

Further, in the first exemplary embodiment, when receiving a recording instruction from any of the terminal devices 501 and 502 used by some user, the content delivery system acquires the content data specified by that recording instruction. Then, the content delivery system converts the format of the acquired content data into a format playable by any of the terminal devices 501 and 502 used by the user. In addition, the content delivery system stores the acquired content data and the converted content data.

By virtue of this, it is possible to reduce the processing load on the content delivery system more than when the content delivery system converts the formats of all content data. Further, according to the above configuration, because the content delivery system stores the acquired content data and the converted content data, it is possible to swiftly send the content data when receiving a transmission request from any of the terminal devices 501 and 502.

### A Second Exemplary Embodiment

Next, explanations will be made with respect to a content playing system in accordance with a second exemplary embodiment of the present invention. The content playing system in accordance with the second exemplary embodiment is different from the content playing system in accordance with the first exemplary embodiment in the aspect that the content delivery system temporarily stores all received content data. Therefore, the following explanations will focused on the difference.

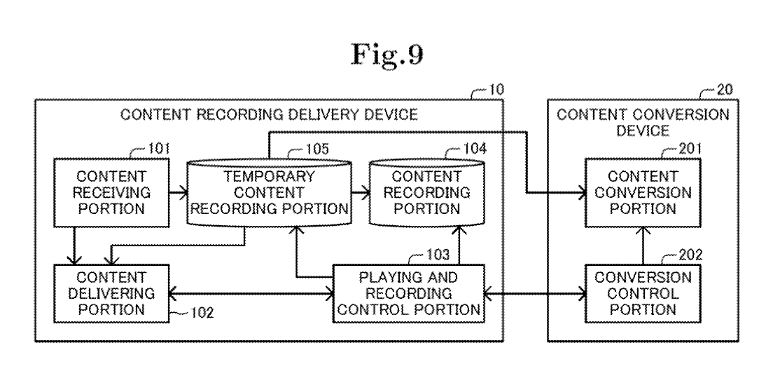

The content recording delivery device 10 in accordance with the second exemplary embodiment is, as shown in FIG. 9, provided with a temporary content recording portion 105, in addition to the constituent members of the content recording delivery device 10 in accordance with the first exemplary embodiment.

The temporary content recording portion 105 stores all the content data received by the content receiving portion 101 from the time of receiving the content data until a preset retention period has passed. A conceivable usage is to collectively record mainly multi-channel broadcast programs.

By virtue of this, the content delivery system can send a content data stored in the temporary content recording portion 105 even if the user has not carried out the recording reservation process for the content data.

Therefore, the user can play a broadcast program from the beginning even after the broadcast is started. Further, the terminal devices 501 and 502 can carry out a catch-up play by fast feeding to catch up the broadcast time. Such kind of playing method is referred to as a time shift play. By virtue of such configuration, even if the user forgets to reserve the recording and begins to record after the broadcast is started, it is still possible to record the content data into the content recording portion 104 from the beginning.

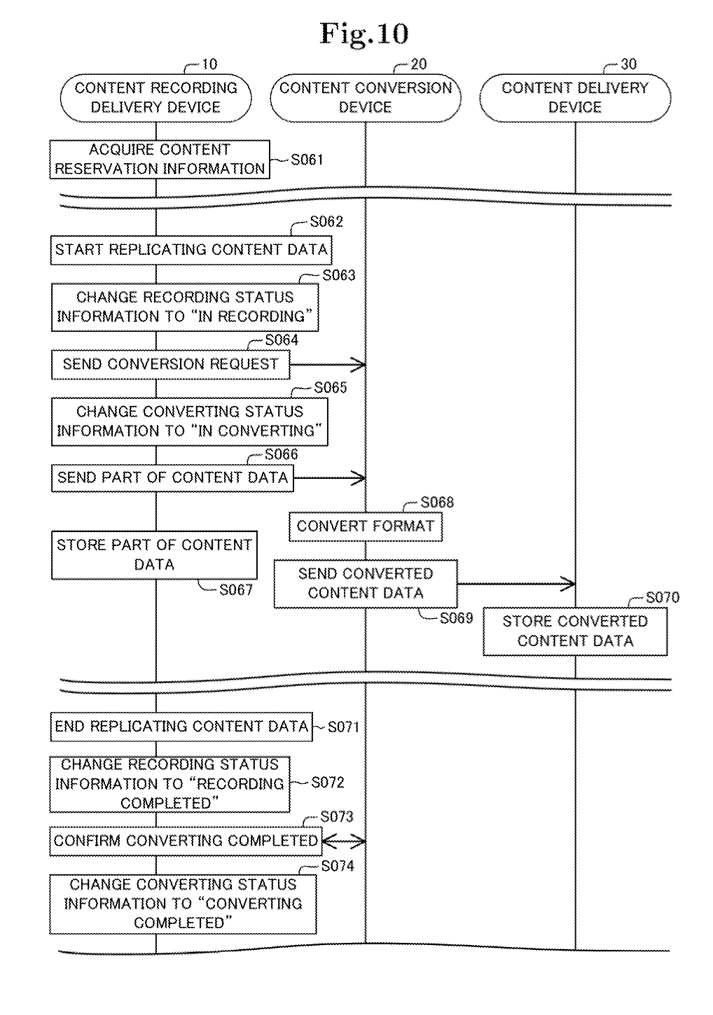

Referring to FIG. 10, explanations will be made with respect to the operation of the content playing system 1 configured in this manner and related to a recording process for recording a broadcast program.

The content playing system 1 carries out the same process as in the case shown in FIG. 5 except for the processes of steps S062 and S071. In step S062, at the start time of the date denoted by the acquired content reservation information, the content recording delivery device 10 starts replicating the content data into the content recording portion 104 from the temporary content recording portion 105. Further, in step S071, at the end time of the date denoted by the acquired content reservation information, the content recording delivery device 10 ends replicating the content data into the content recording portion 104 from the temporary content recording portion 105

Further, the content recording delivery device 10 is configured to start replicating the content data into the content recording portion 104 from the temporary content recording portion 105 at the start time of broadcast when the contents are a broadcast program. However, it may as well be configured to carry out the replication collectively at the end time of broadcast.

Further, the content recording portion 104 is configured to store a plurality of replicas of a content data when a plurality of users send the recording instructions for the same content data. However, it may as well be configured to store only one replica of the content data (that is, not to store the same content data repeatedly).

According to the second exemplary embodiment, it is also possible to achieve the same function and effect as the first exemplary embodiment.

### A Third Exemplary Embodiment

Next, explanations will be made with respect to a content playing system in accordance with a third exemplary embodiment of the present invention. The content playing system in accordance with the third exemplary embodiment is different from the content playing system in accordance with the first exemplary embodiment in the aspect that it is configured to convert the format of the content data when the content delivery system 30 receives a transmission request. Therefore, the following explanations will focused on the difference.

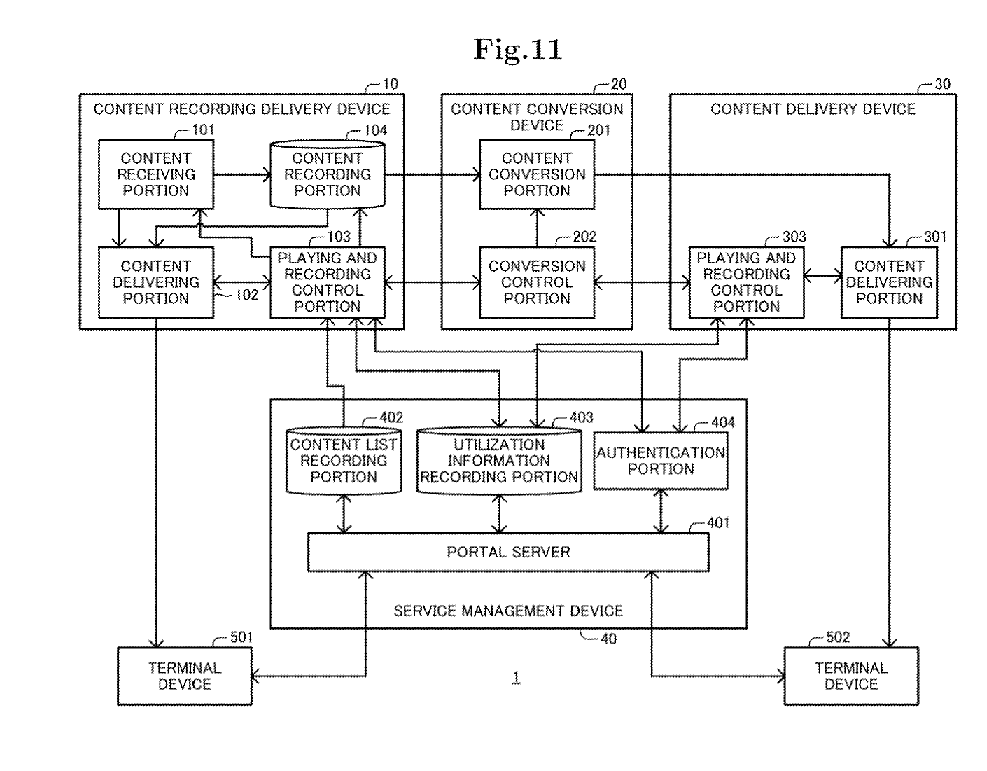

As shown in FIG. 11, the content delivery device 30 in accordance with the third exemplary embodiment is configured to have removed the converted content recording portion 302 from configuration of the content delivery device 30 in accordance with the first exemplary embodiment.

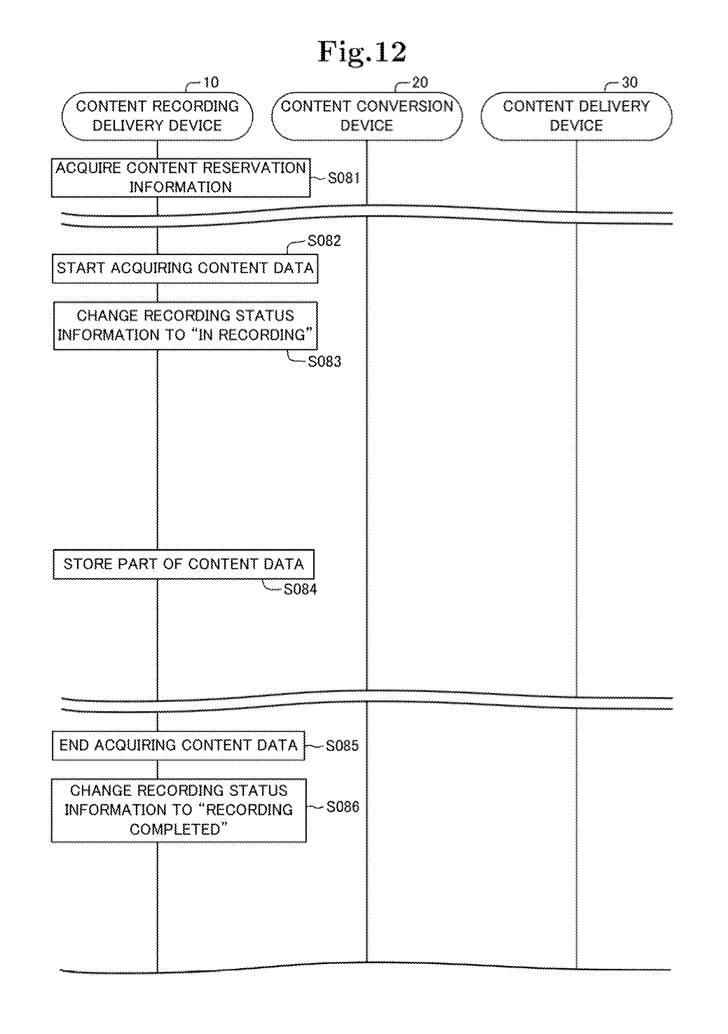

Next, explanations will be made with respect to operations of the content playing system 1 in accordance with the third exemplary embodiment. Referring to FIG. 12, explanations will be made with respect to the operation of the content playing system 1 configured in this manner and related to a recording process for recording a broadcast program.

The content playing system 1 does not carry out the processes of steps S024 to S026, steps S028 to S030, and steps S033 to S034 among those shown in FIG. 5. That is, when the content recording delivery device 10 stores a content data into the content recording portion 104, the content conversion device 20 does not convert the format of the content data.

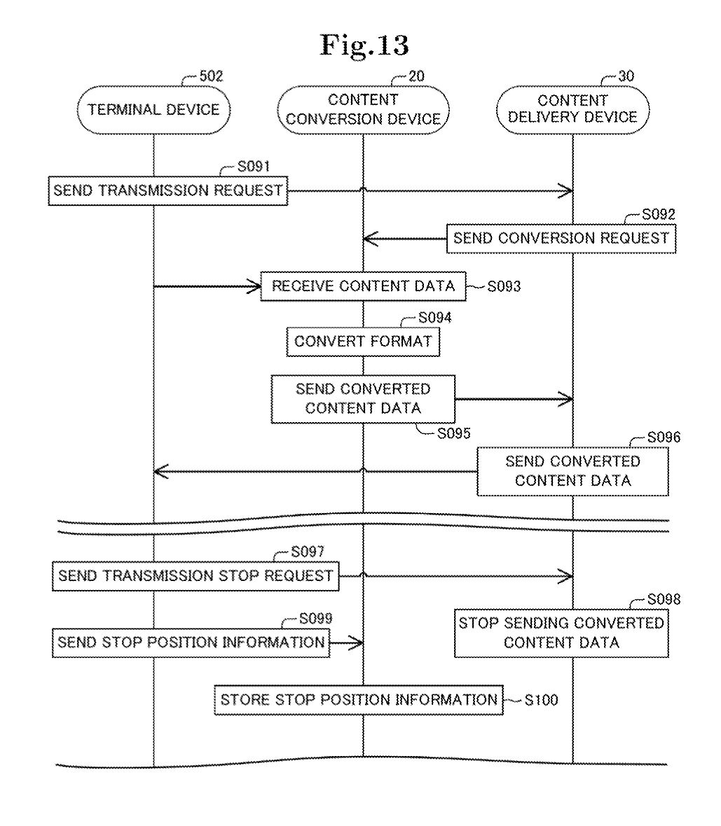

Next, referring to FIG. 13, explanations will be made with respect to the operation of the content playing system 1 relative to a playing process for the user to play contents on the terminal device 502.

In the same manner as in step S051 of FIG. 7, the terminal device 502 sends a recording content list request to the service management device 40. By virtue of this, in the same manner as in step S052 of FIG. 7, the service management device 40 generates a recording content list denoting a content chart transmittable to the terminal device 502 (the user of the terminal device 502 can play the contents), and sends the generated recording content list to the terminal device 502.

On receiving the recording content list from the service management device 40, the terminal device 502 displays the content chart denoted by the received recording content list. The user of the terminal device 502 selects the contents desired to play and inputs a transmission request instruction denoting the selected contents while referring to the displayed content chart.

The terminal device 502 sends a transmission request including the content specification information and the playing start position information to the content delivery device 30 according to the inputted transmission request instruction (step S091).

On receiving the transmission request from the terminal device 502, the content delivery device 30 sends a conversion request including the format specification information (information denoting the second format in the present example) and the content data identification information for identifying the contents specified by the transmission request to the content conversion device 20 (step S092).

At the time, the content delivery device 30 acquires the terminal information associated with the terminal device which sent in the transmission request (that is, the terminal device 502) among the terminal information stored in the utilization information recording portion 403. Then, the content delivery device 30 utilizes the format specification information included in the acquired terminal information as the format specification information included in the above conversion request.

On receiving the conversion request from the content delivery device 30, the content conversion device 20 acquires (receives) the content data identified by the conversion request from the content recording delivery device 10 (step S093). Then, on receiving the content data, the content conversion device 20 converts the format of the received content data from the first format into a format specified by the received conversion request (the second format in the present example) (step S094).

Next, the content conversion device 20 sends the converted content data (conversion-completed content data) to the content delivery device 30 (step S095). By virtue of this, the content delivery device 30 receives the converted content data.

Then, the content delivery device 30 sends the content data denoting the contents specified by the above transmission request (the converted content data having the second format) to the terminal device 502 from the position denoted by the playing start position information included in the transmission request (step S096).

On receiving the content data from the content delivery device 30, the terminal device 502 plays the contents denoted by the received content data. By virtue of this, the user of the terminal device 502 can play the contents from the position at which the terminal device 501 has stopped the play (that is, the rest of the contents which were played by the terminal device 501 in the past).

According to the third exemplary embodiment, it is also possible to achieve the same function and effect as the first exemplary embodiment.

Further, in the third exemplary embodiment too, if the terminal device 502 carries out a trick play, the user can play the contents while trick-playing by the content conversion portion 201 changing the position of the contents read out from the content recording portion 104 for conversion according to the playing position of the contents.

### A Fourth Exemplary Embodiment

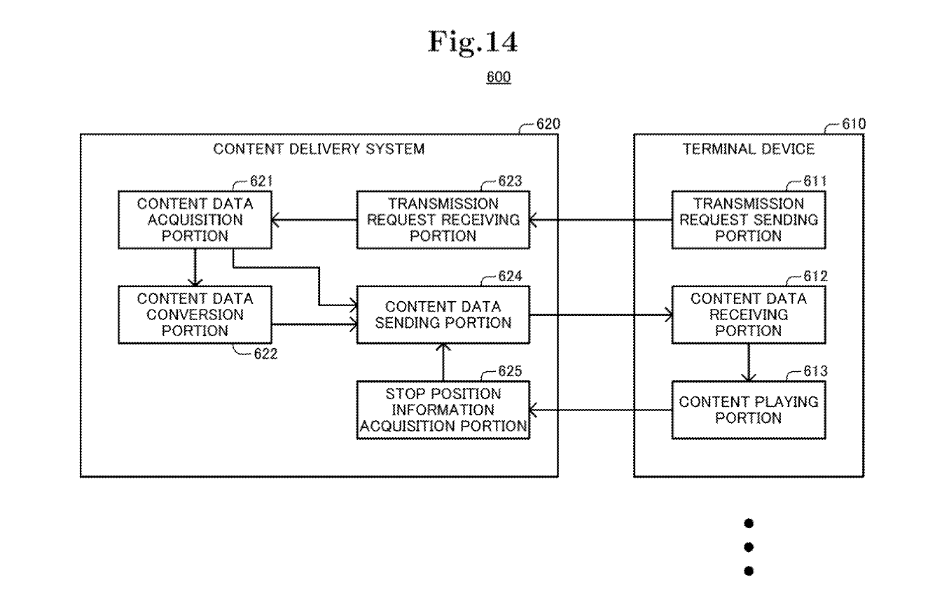

Next, referring to FIG. 14, explanations will be made with respect to a content playing system in accordance with a fourth exemplary embodiment of the present invention. A content playing system 600 includes: a plurality of terminal devices 610, etc.; and a content delivery system 620.

Further, each of the terminal devices 610, etc. includes: a transmission request sending portion 611 (a transmission request sending means) for sending a transmission request for requesting to send a content data denoting contents to the content delivery system 620, a content data receiving portion 612 (a content data receiving means) for receiving the content data from the content delivery system 620, and a content playing portion 613 (a content playing means) for playing the contents denoted by the received content data.

In addition, the content delivery system 620 includes: a content data acquisition portion 621 (a content data acquisition means) for acquiring the content data having a first format, a content data conversion portion 622 (a content data conversion means) for converting the format of the acquired content data from the first format into a second format different from the first format, a transmission request receiving portion 623 (a transmission request receiving means) for receiving the transmission request from any of the terminal devices, a content data sending portion 624 (a content data sending means) for sending the content data having the first format or the content data having the second format to the terminal device 610, etc. which sent in the transmission request when the transmission request was received, and a stop position information acquisition portion 625 (a stop position information acquisition means) for acquiring stop position information denoting a stop position when the terminal device 610, etc. has stopped playing the contents.

Further, the content data sending portion 624 is configured such that after one of the plurality of terminal devices 610, etc. has stopped playing the contents, in the case of receiving the transmission request sent by another one of the plurality of terminal devices 610, etc., it sends the content data to the other one of the terminal devices 610, etc. from the position denoted by the acquired stop position information.

According to the above configuration, when receiving a transmission request from any of the terminal device 610, etc., the content delivery system 620 can send a content data having a format playable by the terminal devices 610, etc. to any of the terminal devices 610, etc. By virtue of this, the user can play the contents even when utilizing any of the plurality of terminal devices 610, etc. different in the format for playable content data.

Further, according to the content playing system 600, when the user, who was playing the contents on a first terminal device, once stops the play, he/she can restart to play the contents on a second terminal device later. That is, the user can continuously play the contents between the plurality of terminal devices different in the format for playable content data. As a result, it is possible to enhance the convenience for the user.

In this case, it is preferable that the plurality of terminal devices include a first terminal device configured to be able to play the contents denoted by a content data based on the content data having the first format, and a second terminal device configured to be able to play the contents denoted by another content data based on the content data having the second format; and the content data sending means is configured to send the content data having the first format to the first terminal device and send the content data having the second format to the second terminal device.

In this case, it is preferable that the content delivery system include a stop position information storage means for storing user identification information for identifying the user of the terminal device of the object of the stop position information and the stop position information in association with each other when the stop position information is acquired; and the content data sending means be configured to send the content data to the terminal device from the position denoted by the stop position information if the stop position information is stored in association with the user identification information for identifying the user of the terminal device in the case of receiving the transmission request sent by the terminal device.

By virtue of this, even if a plurality of users utilize the content playing system, it is still possible for each user to continue playing the contents reliably. As a result, it is possible to enhance the convenience for the users.

In this case, it is preferable that the content delivery system include a format specification information acquisition means for acquiring format specification information for specifying a format with which the terminal devices can play the contents; and the content data conversion means be configured to convert the format of the acquired content data into a format specified by the acquired format specification information.

By virtue of this, the content delivery system can convert the format of the acquired content data into a format with which the terminal devices can play the contents. As a result, the content delivery system can avoid vainly converting the format of the acquired content data into some format with which the terminal devices cannot play the contents.

In this case, it is preferable that the terminal devices include a recording instruction sending means for sending a predetermined recording instruction including content specification information for specifying contents to the content delivery system; the content delivery system include a format specification information storage means for storing the format specification information for specifying the format with which the terminal device utilized by a user can play the contents in association with user identification information for identifying the user, and a recording instruction receiving means for receiving the recoding instruction from the terminal device; the content data acquisition means be configured to acquire the content data denoting the contents specified by the content specification information included in the received recording instruction; the content data conversion means be configured to convert the format of the acquired content data into the format specified by the format specification information stored in association with the user identification information for identifying the user of the terminal device which sent in the recording instruction when acquiring the content data denoting the contents specified by the content specification information included in the received recording instruction; and the content delivery system further include a content data storage means for storing the acquired content data and the converted content data.

By virtue of this, when receiving a recording instruction from any of the terminal devices used by some user, the content delivery system acquires the content data specified by that recording instruction. Then, the content delivery system converts the format of the acquired content data into a format playable by any of the terminal devices used by the user. In addition, the content delivery system stores the acquired content data and the converted content data.

By virtue of this, it is possible to reduce the processing load on the content delivery system more than when the content delivery system converts the formats of all content data. Further, according to the above configuration, because the content delivery system stores the acquired content data and the converted content data, it is possible to swiftly send the content data when receiving a transmission request from any of the terminal devices.

In this case, it is preferable that the content data conversion means be configured to convert the format of the acquired part of the content data when part of the content data is acquired.

By virtue of this, the content delivery system can send the converted content data to the terminal device before acquiring all the content data. Therefore, for example, even if the content data is delivered through broadcasting from an external device to the content delivery system, the terminal device can still play the contents during the delivery of the content data.

Further, another aspect in accordance with the present invention provides a content delivery method for application to a content playing system including a plurality of terminal devices and a content delivery system.

Further, the content delivery method includes: acquiring a content data denoting a content and having a first format by the content delivery system; converting the format of the acquired content data from the first format into a second format different from the first format by the content delivery system; sending a transmission request for requesting to send the content data denoting the content to the content delivery system by the terminal device; receiving the transmission request from the terminal device by the content delivery system; sending the content data having the first format or the content data having the second format by the content delivery system to the terminal device which sent in the transmission request when the transmission request was received; receiving the content data from the content delivery system by the terminal device; playing the content denoted by the received content data by the terminal device; acquiring, when the terminal device has stopped playing the content, stop position information denoting the stopped position by the content delivery system; and in the case of receiving, after one of the plurality of terminal devices has stopped playing the content, the transmission request sent by another one of the plurality of terminal devices, sending the content data to the other terminal device from the position denoted by the acquired stop position information, by the content delivery system.

In this case, the plurality of terminal devices include a first terminal device configured to be able to play the content denoted by a content data based on the content data having the first format, and a second terminal device configured to be able to play the content denoted by another content data based on the content data having the second format; and the content delivery method is configured such that the content delivery system sends the content data having the first format to the first terminal device and send the content data having the second format to the second terminal device.

In this case, the content delivery method further includes: storing, by means of the content delivery system, user identification information for identifying the user of the terminal device of the object of the stop position information and the stop position information in association with each other when the stop position information is acquired; and sending, by means of the content delivery system, the content data to the terminal device from the position denoted by the stop position information if the stop position information is stored in association with the user identification information for identifying the user of the terminal device in the case of receiving the transmission request sent by the terminal device.

Further, still another aspect in accordance with the present invention provides a content delivery system configured to be communicable with each of a plurality of terminal devices.

Further, the content delivery system includes: a content data acquisition means for acquiring a content data denoting a content and having a first format; a content data conversion means for converting the format of the acquired content data from the first format into a second format different from the first format; a transmission request receiving means for receiving a transmission request for requesting to send the content data from the terminal device; a content data sending means for, when the transmission request was received, sending the content data having the first format or the content data having the second format to the terminal device which sent in the transmission request; and a stop position information acquisition means for, when the terminal device has stopped playing the content, acquiring stop position information denoting the stopped position, wherein the content data sending means is configured to, in the case of receiving, after one of the plurality of terminal devices has stopped playing the content, the transmission request sent by another one of the plurality of terminal devices, send the content data to the other terminal device from the position denoted by the acquired stop position information.

In this case, it is preferable that the plurality of terminal devices include a first terminal device configured to be able to play the content denoted by a content data based on the content data having the first format, and a second terminal device configured to be able to play the content denoted by another content data based on the content data having the second format; and the content data sending means be configured to send the content data having the first format to the first terminal device and send the content data having the second format to the second terminal device.

In this case, it is preferable that the content delivery system further include a stop position information storage means for storing user identification information for identifying the user of the terminal device of the object of the stop position information and the stop position information in association with each other when the stop position information is acquired, wherein the content data sending means be configured to send the content data to the terminal device from the position denoted by the stop position information if the stop position information is stored in association with the user identification information for identifying the user of the terminal device in the case of receiving the transmission request sent by the terminal device.

Further, still another aspect in accordance with the present invention provides a computer program including instructions for causing a content delivery device configured to be communicable with each of a plurality of terminal devices to realize: a content data acquisition means for acquiring a content data denoting a content and having a first format; a content data conversion means for converting the format of the acquired content data from the first format into a second format different from the first format; a transmission request receiving means for receiving a transmission request for requesting to send the content data from the terminal device; a content data sending means for, when the transmission request was received, sending the content data having the first format or the content data having the second format to the terminal device which sent in the transmission request; and a stop position information acquisition means for, when the terminal device has stopped playing the content, acquiring stop position information denoting the stopped position, wherein the content data sending means is configured to, in the case of receiving, after one of the plurality of terminal devices has stopped playing the content, the transmission request sent by another one of the plurality of terminal devices, send the content data to the other terminal device from the position denoted by the acquired stop position information.

In this case, it is preferable that the plurality of terminal devices include a first terminal device configured to be able to play the content denoted by a content data based on the content data having the first format, and a second terminal device configured to be able to play the content denoted by another content data based on the content data having the second format; and the content data sending means is configured to send the content data having the first format to the first terminal device and send the content data having the second format to the second terminal device.

In this case, it is preferable that computer program further include instructions for causing the content delivery device to realize a stop position information storage means for causing a storage device to store, when the stop position information is acquired, user identification information for identifying the user of the terminal device for the stop position information and the stop position information in association with each other, wherein the content data sending means is configured to send the content data to the terminal device from the position denoted by the stop position information if the stop position information is stored in association with the user identification information for identifying the user of the terminal device in the case of receiving the transmission request sent by the terminal device.

Any inventions of content delivery methods, content delivery systems or computer programs having the above configurations can also achieve the aforementioned object of the present invention because of having the same function as the above content playing system.

While the present invention has been particularly shown and described with reference to the above exemplary embodiments, the present invention is not limited to these embodiments. It will be understood by those of ordinary skill in the art that various changes in form and details may be made therein without departing from the spirit and scope of the present invention as defined by the claims.

For example, in each of the above exemplary embodiments, the service management device 40 is configured to send the stop position information to the content recording delivery device 10 or the content delivery device 30 through any of the terminal devices 501 and 502. However, the service management device 40 may as well be configured to send the same to the content recording delivery device 10 or the content delivery device 30 without passing through the terminal devices 501 and 502 (that is, directly).

Further, in a modification of the above respective exemplary embodiments, the content playing system 1 may as well be configured such that the content recording portion 104 and/or the converted content recording portion 302 may store content data encrypted by a predetermined encryption scheme (for example, CAS: Conditional Access Systems, or the like). By virtue of this, it is possible to let the predetermined terminal devices 501 and 502 only play the contents.

Further, in another modification of the above respective exemplary embodiments, the content playing system 1 may as well be configured to define the service usable by the user based on the information stored in the utilization information recording portion 403. Further, the content playing system 1 may as well be configured to carry out a charging process according to the delivered content data.

Further, in each of the above exemplary embodiments, the content receiving portion 101 may receive as the content data either programs by terrestrial TV broadcasting, satellite broadcasting, cable TV broadcasting and the like, or programs broadcasted via IP (Internet Protocol) network such as retransmission of terrestrial digital broadcasting (linear TV broadcasting). In this case, the content data may transmitted by either multicast or unicast.

Further, it is preferable that the content receiving portion 101 be configured to acquire a content data by digitizing (encoding) the received contents when receiving the contents with analog signals.

Further, the content receiving portion 101 may be configured to decode the received content data to allow redelivery by network PVR (Personal Video Recorder) if the received content data is encrypted.

Further, if the contents are VoD contents or personal home videos, then the playing and recording control portion 103 cannot control the recording with the broadcasting hours. Therefore, it is preferable that the content playing system 1 be configured to regard the recording as completed at the time of ending download of VoD contents or upload of personal home videos.

Further, in each of the above exemplary embodiments, the terminal devices 501 and 502 are a set-top box and a cellular telephone. However, they may as well be personal computers, portable game devices, PHSs (Personal Handyphone Systems), PDAs (Personal Data Assistance or Personal Digital Assistant), car navigation system terminals, portable music players, or the like.

Further, in each of the above exemplary embodiments, although each function of the content playing system 1 is realized by the CPU executing a computer program (software), it may as well be realized by hardware such as an electronic circuit and the like.

Further, in each of the above exemplary embodiments, although computer programs are stored in a storage device, they may as well be stored in a recording medium readable by a computer. For example, the recording medium may be a portable medium such as a flexible disk, optical disk, magneto-optical disk, semiconductor memory, and the like.

Further, any combinations of the aforementioned exemplary embodiments and modifications may be adopted as other modifications of the above exemplary embodiments.

Further, the present application claims priority from Japanese Patent Application No. 2009-142281, filed on Jun. 15, 2009 in Japan, the disclosure of which is incorporated herein by reference in its entirety.

### INDUSTRIAL APPLICABILITY

The present invention is applicable to network PVR and the like for managing contents of recorded broadcast programs with a server device.

### REFERENCE SIGNS LIST

1 Content playing system

10 Content recording delivery device

20 Content conversion device

30 Content delivery device

40 Service management device

101 Content receiving portion

102 Content delivering portion

103 Playing and recording control portion

104 Content recording portion

105 Temporary content recording portion

201 Content conversion portion

202 Conversion control portion

301 Content delivering portion

302 Converted content recording portion

303 Playing and recording control portion

401 Portal server

402 Content list recording portion

403 Utilization information recording portion

404 Authentication portion

501, 502 Terminal devices

600 Content playing system

610, etc. Terminal devices

611 Transmission request sending portion

612 Content data receiving portion

613 Content playing portion

620 Content delivery system

621 Content data acquisition portion

622 Content data conversion portion

623 Transmission request receiving portion

624 Content data sending portion

625 Stop position information acquisition portion

NW Communications line

1. A content playing system comprising:
a plurality of terminal devices; and
a content delivery system,
wherein each of the plurality of terminal devices comprises: a transmission request sending unit for sending a transmission request for requesting to send a content data denoting a content to the content delivery system, a content data receiving unit for receiving the content data from the content delivery system, and a content playing unit for playing the content denoted by the received content data;
wherein the content delivery system comprises: a content data acquisition unit for acquiring the content data having a first format, a content data conversion unit for converting the format of the acquired content data from the first format into a second format different from the first format, a transmission request receiving unit for receiving the transmission request from the terminal device, a content data sending unit for, when the transmission request was received, sending the content data having the first format or the content data having the second format to the terminal device which sent in the transmission request, and a stop position information acquisition unit for, when the terminal device has stopped playing the content, acquiring stop position information denoting the stopped position; and
wherein the content data sending means is configured to, in the case of receiving, after one of the plurality of terminal devices has stopped playing the content, the transmission request sent by another one of the plurality of terminal devices, send the content data to the other terminal device from the position denoted by the acquired stop position information.

2. The content playing system according to claim 1, wherein the plurality of terminal devices include a first terminal device configured to be able to play the content denoted by a content data based on the content data having the first format, and a second terminal device configured to be able to play the content denoted by another content data based on the content data having the second format; and the content data sending means is configured to send the content data having the first format to the first terminal device and send the content data having the second format to the second terminal device.

3. The content playing system according to claim 1, wherein the content delivery system comprises a stop position information storage unit for, when the stop position information is acquired, storing user identification information for identifying the user of the terminal device for the stop position information and the stop position information in association with each other; and the content data sending means is configured to send the content data to the terminal device from the position denoted by the stop position information if the stop position information is stored in association with the user identification information for identifying the user of the terminal device in the case of receiving the transmission request sent by the terminal device.

4. The content playing system according to claim 1, wherein the content delivery system comprises a format specification information acquisition unit for acquiring format specification information for specifying a format with which the terminal device can play the content; and the content data conversion means is configured to convert the format of the acquired content data into a format specified by the acquired format specification information.

5. The content playing system according to claim 4, wherein the terminal device comprises a recording instruction sending unit for sending a predetermined recording instruction including content specification information for specifying a content to the content delivery system; the content delivery system comprises a format specification information storage unit for storing the format specification information for specifying the format with which the terminal device utilized by a user can play the content in association with user identification information for identifying the user, and a recording instruction receiving unit for receiving the recoding instruction from the terminal device; the content data acquisition means is configured to acquire the content data denoting the content specified by the content specification information included in the received recording instruction; the content data conversion means is configured to convert the format of the acquired content data into the format specified by the format specification information stored in association with the user identification information for identifying the user of the terminal device which sent in the recording instruction when acquiring the content data denoting the content specified by the content specification information included in the received recording instruction; and the content delivery system further comprises a content data storage unit for storing the acquired content data and the converted content data.

6. The content playing system according to claim 1, wherein the content data conversion means is configured to, when a part of the content data is acquired, convert the format of the acquired part of the content data.

7. A content delivery method for application to a content playing system comprising a plurality of terminal devices and a content delivery system, the method comprising:
acquiring a content data denoting a content and having a first format by the content delivery system;
converting the format of the acquired content data from the first format into a second format different from the first format by the content delivery system;
sending a transmission request for requesting to send the content data denoting the content to the content delivery system by the terminal device;
receiving the transmission request from the terminal device by the content delivery system;
sending the content data having the first format or the content data having the second format by the content delivery system to the terminal device which sent in the transmission request when the transmission request was received;
receiving the content data from the content delivery system by the terminal device;
playing the content denoted by the received content data by the terminal device;
acquiring, when the terminal device has stopped playing the content, stop position information denoting the stopped position by the content delivery system; and
in the case of receiving, after one of the plurality of terminal devices has stopped playing the content, the transmission request sent by another one of the plurality of terminal devices, sending the content data to the other terminal device from the position denoted by the acquired stop position information, by the content delivery system.

8. The content delivery method according to claim 7, wherein the plurality of terminal devices include a first terminal device configured to be able to play the content denoted by a content data based on the content data having the first format, and a second terminal device configured to be able to play the content denoted by another content data based on the content data having the second format;
the method comprising:
sending the content data having the first format to the first terminal device and sending the content data having the second format to the second terminal device, by the content delivery system.

9. The content delivery method according to claim 7 further comprising: storing, when the stop position information is acquired, user identification information for identifying the user of the terminal device for the stop position information and the stop position information in association with each other, by the content delivery system; and sending, by the content delivery system, the content data to the terminal device from the position denoted by the stop position information if the stop position information is stored in association with the user identification information for identifying the user of the terminal device in the case of receiving the transmission request sent by the terminal device.

10. A content delivery system configured to be communicable with each of a plurality of terminal devices, the system comprising:
a content data acquisition unit for acquiring a content data denoting a content and having a first format;
a content data conversion unit for converting the format of the acquired content data from the first format into a second format different from the first format;
a transmission request receiving unit for receiving a transmission request for requesting to send the content data from the terminal device;
a content data sending unit for, when the transmission request was received, sending the content data having the first format or the content data having the second format to the terminal device which sent in the transmission request; and
a stop position information acquisition unit for, when the terminal device has stopped playing the content, acquiring stop position information denoting the stopped position,
wherein the content data sending means is configured to, in the case of receiving, after one of the plurality of terminal devices has stopped playing the content, the transmission request sent by another one of the plurality of terminal devices, send the content data to the other terminal device from the position denoted by the acquired stop position information.

11. The content delivery system according to claim 10, wherein the plurality of terminal devices include a first terminal device configured to be able to play the content denoted by a content data based on the content data having the first format, and a second terminal device configured to be able to play the content denoted by another content data based on the content data having the second format; and the content data sending means is configured to send the content data having the first format to the first terminal device and send the content data having the second format to the second terminal device.

12. The content delivery system according to claim 10 further comprising a stop position information storage unit for storing, when the stop position information is acquired, user identification information for identifying the user of the terminal device for the stop position information and the stop position information in association with each other, wherein the content data sending means is configured to send the content data to the terminal device from the position denoted by the stop position information if the stop position information is stored in association with the user identification information for identifying the user of the terminal device in the case of receiving the transmission request sent by the terminal device.

13. (canceled)

14. (canceled)

15. (canceled)
